(19) United States
(12) Patent Application Publication
(10) Pub. No.: US 2016/0167690 A1
(43) Pub. Date: Jun. 16, 2016

(54) FOLDED TROLLEY STRUCTURE AND TROLLEY

(71) Applicant: Dongguan Q PID Baby Product Co., Ltd., Dongguan (CN)

(72) Inventor: Yuan-Chih LIN, Dongguan (CN)

(21) Appl. No.: 14/806,611

(22) Filed: Jul. 22, 2015

(30) Foreign Application Priority Data
Dec. 16, 2014 (CN) 201420801588.6

(51) Int. Cl. B62B 7/06

(52) U.S. Cl. CPC B62B 7/062

(57) ABSTRACT

The present invention discloses a folded trolley structure, which comprises a front rod, a handle stem, a rear rod, a first support rod and a second support rod, wherein a fixing block fixed on the rear rod is disposed on the rear rod; the slider is provided with a control hole; the rear rod is provided with a movable button and a return spring capable of allowing the button to be extended out of the rear rod and into the control hole; an elastically movable pull member is articulated on the fixing block; a first clamping member is disposed on the pull member; a second clamping member corresponding to the first clamping member is disposed on the slider; after the clamped connection between the first clamping member and the second clamping member, the slider and the fixing block are mutually fixed and cannot be separated.

### FIELD OF THE INVENTION

The present invention relates to a folded trolley structure, in particular to a folded trolley structure having the advantages of simple structure, convenient use and convenient carrying. The present invention further relates to a trolley.

### BACKGROUND OF THE INVENTION

Currently, the trolley structure on the market comprises a frame and a seat and wheels disposed on the frame. In the current society, people have large range of motion. Thus, trolleys must be foldable to reduce the space volume, can be more conveniently carried, can be more easily unfolded, and can be immediately used conveniently.

### SUMMARY OF THE INVENTION

The technical problem to be solved by the present invention is to provide a folded trolley structure. The folded trolley structure is foldable so as to reduce the space volume, is convenient to carry, can be rapidly unfolded, and is convenient to use.

The present invention further provides a trolley which is foldable, has a simple structure and is convenient to carry.

The folded trolley structure provided by the present invention may adopt the following technical proposals:

The present invention relates to a folded trolley structure, which comprises a front rod, a handle stem, a rear rod, a first support rod and a second support rod, wherein a slider capable of sliding along the rear rod is disposed on the rear rod; the front rod is articulated with an upper end of the rear rod; the handle stem is articulated with the upper end of the rear rod; an upper end of the first support rod is articulated with the front rod; a lower end of the first support rod is articulated with the slider; an upper end of the second support rod is articulated with the handle stem; a lower end of the second support rod is articulated with the slider; after sliding, the slider can drive the front end and the handle stem to be simultaneously unfolded or folded;

A fixing block fixed on the rear rod is disposed on the rear rod; the slider is provided with a control hole; the rear rod is provided with a movable button and a return spring capable of allowing the button to be extended out of the rear rod and into the control hole; an elastically movable pull member is articulated on the fixing block; a first clamping member is disposed on the pull member; a second clamping member corresponding to the first clamping member is disposed on the slider; after the clamped connection between the first clamping member and the second clamping member, the slider and the fixing block are mutually fixed and cannot be separated; and the rear rod is provided with a slide pin capable of being driven by the button to allow the first clamping member and the second clamping member to be separated when the button is pressed.

The following improvements may be further adopted in the present invention in order to solve the problem:

Further improvement is: the slide pin is disposed in the rear rod; a slide hole capable of allowing the slide pin to be extended out of the rear rod is formed at a position, corresponding to the slide pin, on the rear rod; the slider is provided with an opening at a position corresponding to the slide hole; and the position of the pull member corresponds to that of the slide hole.

Further improvement is: the rear rod is provided with a button hole at a position corresponding to the button.

Further improvement is: one end of the slide pin is articulated with the button and the other end is provided with a hook block; and the button is provided with a small spring capable of moving along with the button, allowing the slide pin and the button to rotate relatively, and hooking the outer edge of the slide hole after the hook block slides to the outside of the rear rod.

Further improvement is: an axis of the return spring and an axis of the slide hole are on the same straight line; the button and the slide pin are articulated with each other through a pivot shaft; and the small spring is disposed between the pivot shaft and the slide hole.

Further improvement is: the first clamping member is a protrusion; and the second clamping member is a bayonet clamped with the protrusion.

Further improvement is: the slider is provided with a roller or a ball which makes contact with the rear rod; and the ball track of the roller or the ball runs through the slide hole.

Further improvement is: the first support rod and the second support rod are disposed on both sides of the rear rod and symmetric relative to the rear rod.

Further improvement is: the rear rod is tubular and is provided with a solid mass at a position corresponding to the button; the solid mass is provided with a cavity; the button is disposed in the cavity; the slide pin is disposed in the cavity; and the size of the cavity is matched with that of the button.

The trolley provided by the present invention adopts the following technical proposal:

The trolley comprises a left component and a right component, wherein the left component and the right component are respectively provided with the foregoing folded trolley structure; a front rod of the folded trolley structure in the left component and a front rod of the folded trolley structure in the right component are connected with each other to form a front frame provided with front wheels; a handle stem of the folded trolley structure in the left component and a handle stem of the folded trolley structure in the right component are connected with each other to form a handle frame; and a rear rod of the folded trolley structure in the left component and a rear rod of the folded trolley structure in the right component are respectively provided with a rear wheel.

The above technical proposals have the following technical effects:

1. The folded structure provided by the present invention is foldable so as to reduce the space volume, is convenient to carry, can be rapidly unfolded, has a stable structure, and is convenient to use. In addition, the folded structure has a simple structure and is easy to manufacture and assemble.

2. The folded structure provided by the present invention is convenient to operate, is simple, and has small volume.

3. The trolley provided by the present invention is foldable, has a simple structure, and is convenient to carry.

### BRIEF DESCRIPTION OF THE DRAWINGS

FIG. 1 is a schematic diagram of a folded structure in a trolley;

FIG. 2 is a schematic structural view of a trolley in which partial components are cut-open;

FIG. 3 is a schematic enlarged view of an A position in FIG. 2;

FIG. 4 is a schematic diagram of a trolley seen from another angle;

FIG. 5 is a schematic enlarged view of a B position in FIG. 4;

FIG. 6 is a schematic partial view illustrating the folding process;

FIG. 7 is a schematic partial view illustrating the folding process; and

FIG. 8 is a schematic enlarged view of a C position in FIG. 7.

### DETAILED DESCRIPTION OF THE PREFERRED EMBODIMENTS

Detailed description will be given below to the present invention with reference to the preferred embodiments.

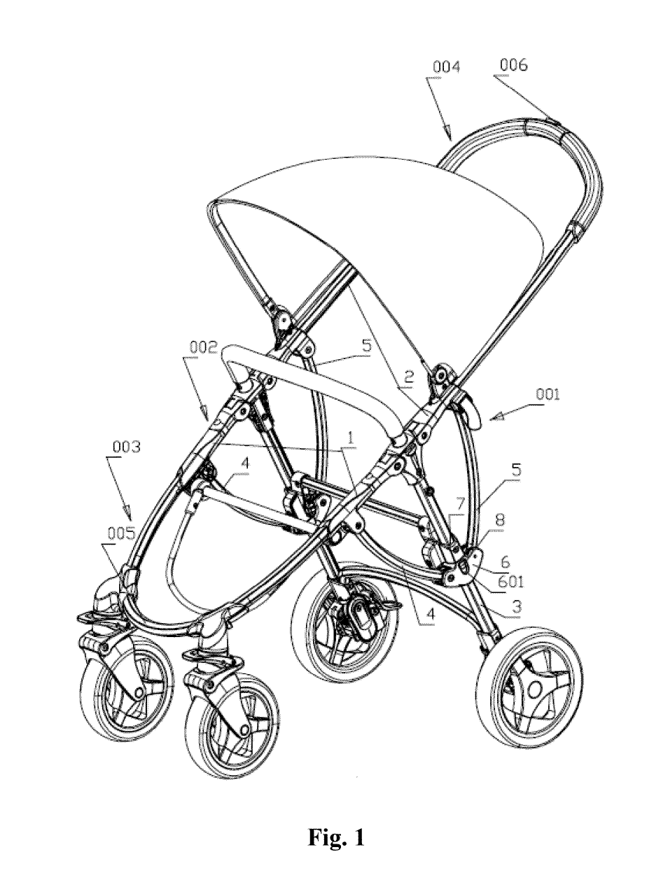

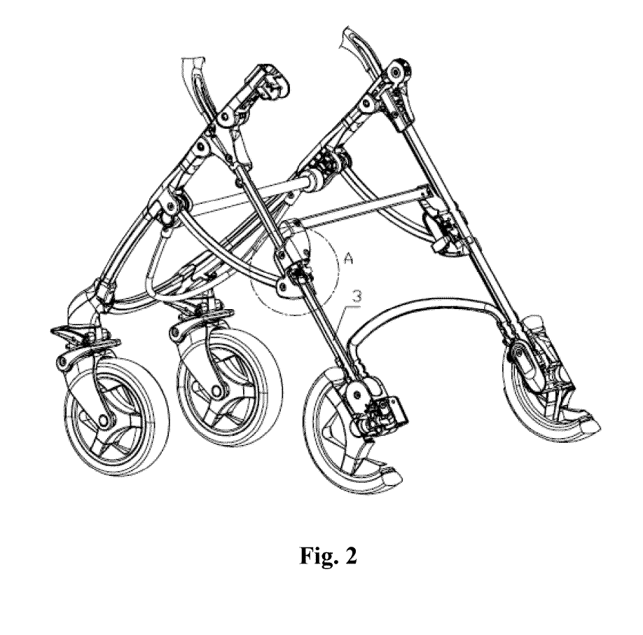

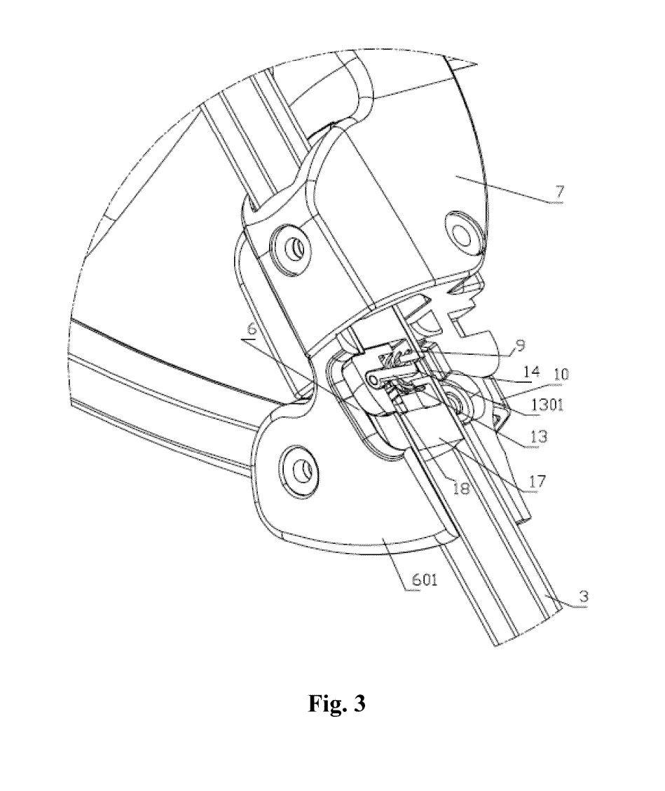

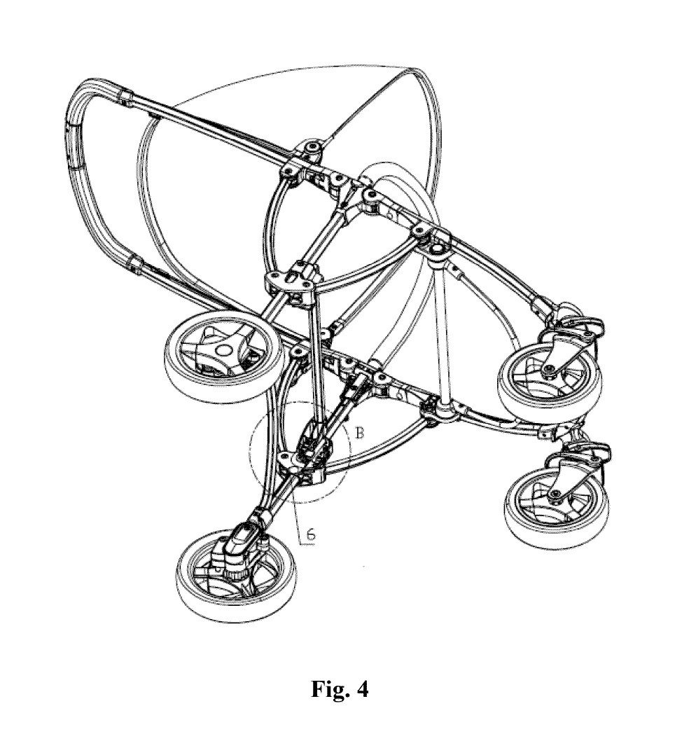

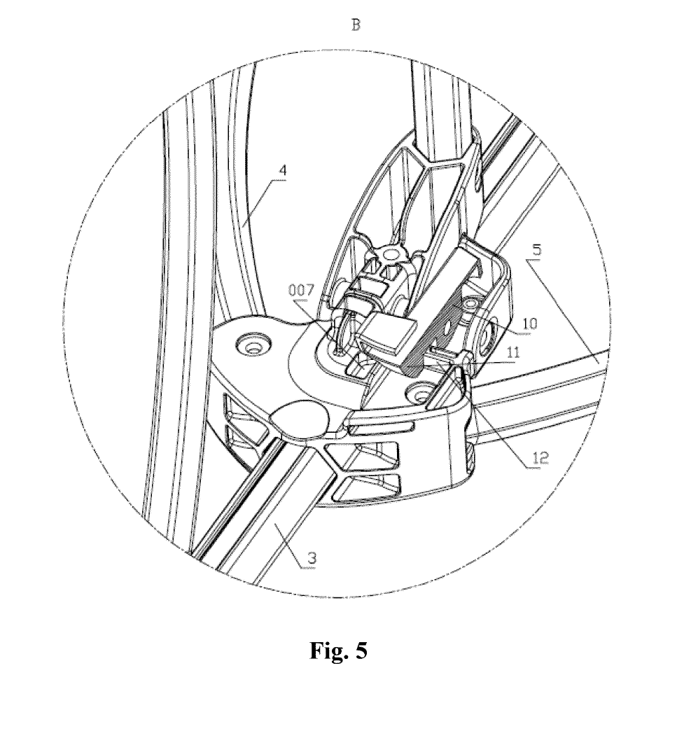

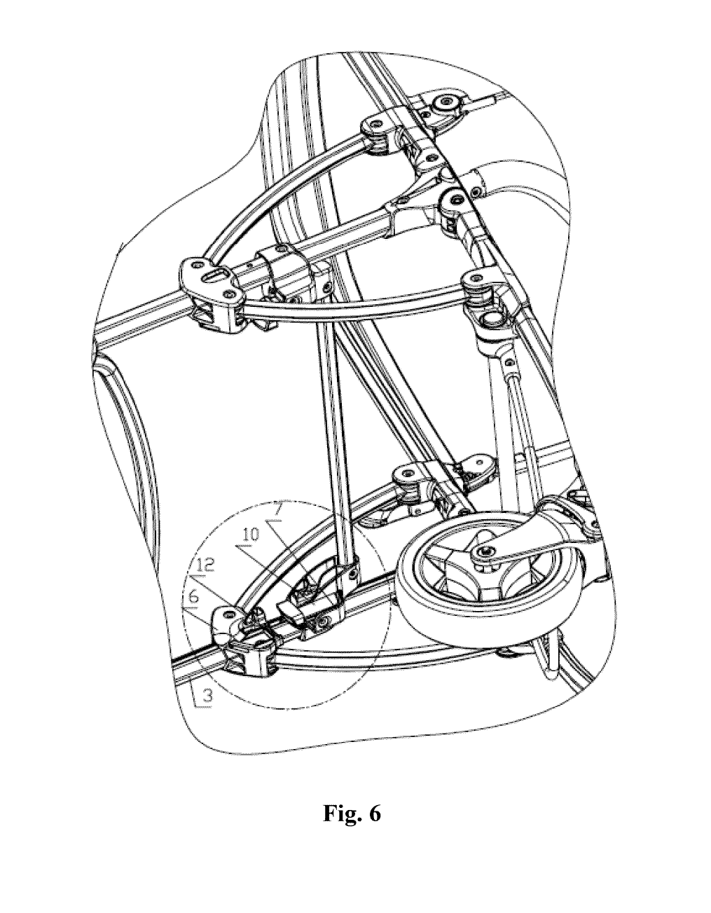

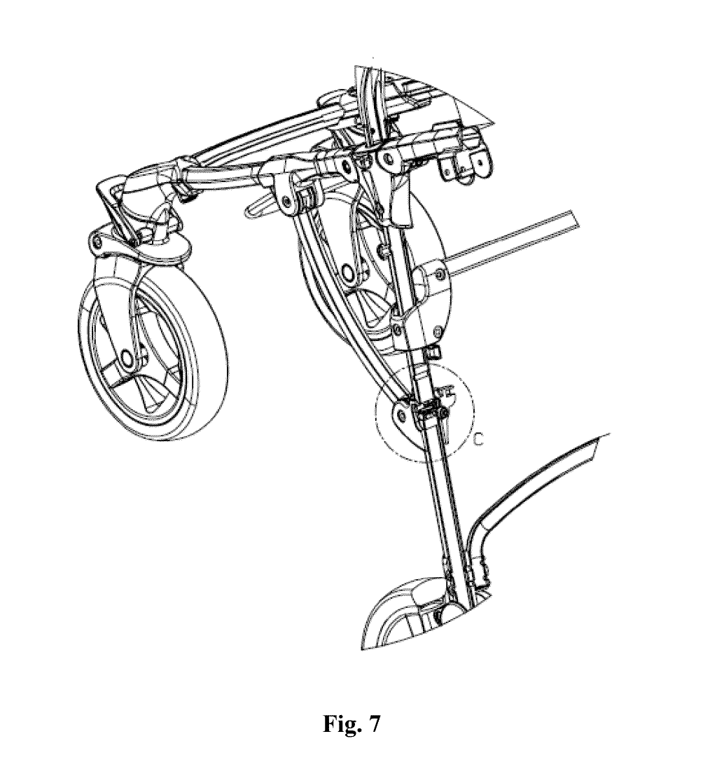

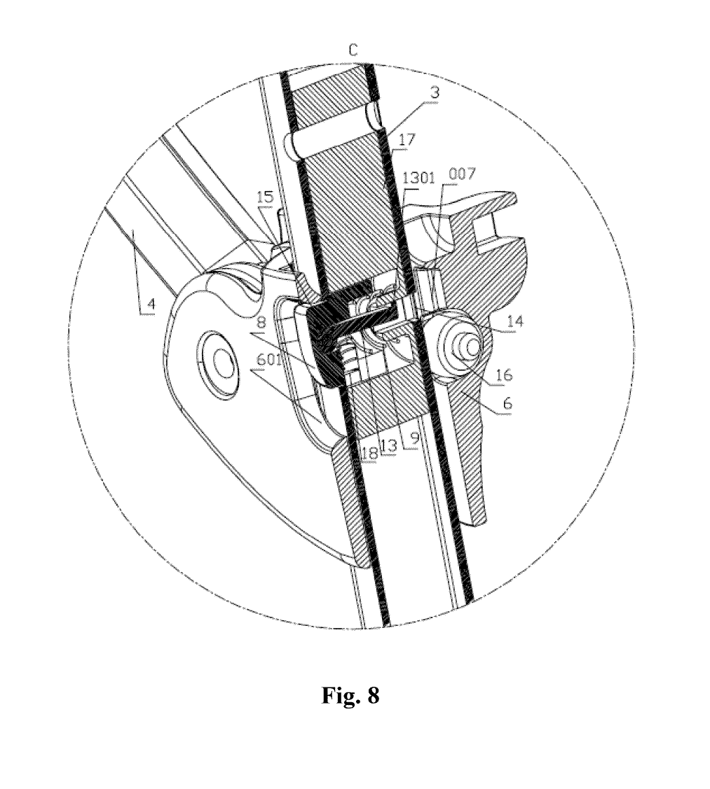

Embodiment: as illustrated in FIGS. 1 to 8, the present invention relates to a folded trolley structure, which comprises a front rod 1, a handle stem 2, a rear rod 3, a first support rod 4 and a second support rod 5, wherein a slider 6 capable of sliding along the rear rod 3 is disposed on the rear rod 3; the front rod 1 is articulated with an upper end of the rear rod 3; the handle stem 2 is articulated with the upper end of the rear rod 3; an upper end of the first support rod 4 is articulated with the front rod 1; a lower end of the first support rod 4 is articulated with the slider 6; an upper end of the second support rod 5 is articulated with the handle stem 2; a lower end of the second support rod 5 is articulated with the slider 6; and after sliding, the slider 6 can drive the front end 1 and the handle stem 2 to be simultaneously unfolded or folded.

A fixing block 7 fixed on the rear rod 3 is disposed on the rear rod 3; the slider 6 is provided with a control hole 601; and the rear rod 3 is provided with a movable button 8 and a return spring 9 capable of allowing the button 8 to be extended out of the rear rod 3 and into the control hole 601. In the embodiment, the return spring 9 abuts against the button 8. An elastically movable pull member 10 (the pull member 10 is articulated with the fixing block 7 through a spring which is not shown in the figure) is articulated on the fixing block 7; a first clamping member 11 is disposed on the pull member 10; and a second clamping member 12 corresponding to the first clamping member 11 is disposed on the slider 6. In the embodiment, one mode is that the first clamping member 11 is a protrusion and the second clamping member 12 is a bayonet clamped with the protrusion. After the clamped connection between the first clamping member 11 and the second clamping member 12, the slider and the fixing block are mutually fixed and cannot be separated; and the rear rod 3 is provided with a slide pin 13 capable of being driven by the button 8 to allow the first clamping member 11 and the second clamping member 12 to be separated when the button 8 is pressed. The slide pin 13 is disposed in the rear rod 3; a slide hole 14 capable of allowing the slide pin 13 to be extended out of the rear rod 3 is formed at a position, corresponding to the slide pin 13, on the rear rod 3; the slider 6 is provided with an opening 007 at a position corresponding to the slide hole 14; and the position of the pull member 10 corresponds to that of the slide hole 14.

The rear rod 3 is provided with a button hole at a position corresponding to the button 8. Due to the button hole, the button 8 can be exposed to the outside of the rear rod 3.

Working principle: the slider 6 moves up to be close to the fixing block 7. At this point, the slider may drive the first support rod 4 and the second support rod 5 to be unfolded and drive the front rod 1 and the handle stem 2 to be unfolded. Thus, the folded structure is in the unfolded state. At this point, as the action of the return spring 9 is applied to the button 8, the slider 6 slides off the button 8 and drives the button 8 to be extended out of the rear rod 3 and disposed in the control hole 601. Meanwhile, as the action of the spring is applied to the pull member 10, the first clamping member 11 and the second clamping member 12 are clamped with each other, namely the protrusion is clamped into the bayonet. Thus, the folded structure can be kept in the unfolded state.

When the folded structure is required to be folded, the button 8 is pressed, and an outer end of the slide pin 13 will run through the opening 007 and push off the pull member 10, so that the pull member 10 can rotate under the action of the spring, namely the first clamping member 11 and the second clamping member 12 are pushed off and separated from each other. In this case, the slider 6 may slide down, and hence the folded structure can be folded. The folded trolley structure is foldable so as to reduce the space volume, is convenient to carry, can be rapidly unfolded, and is convenient to use. The front rods and the handle stems can be unfolded immediately, so that the folding and unfolding speed is rapid. In addition, the folded trolley structure has a simple structure and is easy to manufacture. The front rods and the handle stems can only be folded or unfolded by moving together, so that the structure stability is good. Not only the button 8 can position the slider 6 but also the pull member 10 can fix the slider 6. Thus, the stability of the folded structure can be guaranteed in two aspects, and hence the safety can be achieved.

An improved mode is as follows: one end of the slide pin 13 is articulated with the button 8 and the other end is provided with a hook block 1301; and the button 8 is provided with a small spring 18 capable of moving along with the button 8, allowing the slide pin 13 and the button 8 to rotate relatively, and hooking the outer edge of the slide hole 14 after the hook block 1301 slides to the outside of the rear rod 3. The small spring 18 is disposed in the hole on the button 8. One end of the small spring 18 is fixed in the hole and the other end abuts against the slide pin 13, so that the slide pin 13 can be subjected to an elastic force to produce the moment of rotation. When the button 8 is pressed, the hook block 1301 is extended out of the slide hole 14. Due to the action of the force of the small spring 18, the slide pin 13 is driven to rotate, and the outer end of the slide pin 13 is attached to the wall of the slide hole 14. When hands are released, the hook block 1301 hooks the outer edge of the slide hole 14. In this case, the button 8 cannot bounce due to the force of the return spring 9. At this point, the button is not exposed to the outside of the rear rod 3. Thus, the movement of the slider 6 cannot be hindered, and hence the motion of the slider 6 is convenient.

An improved mode is as follows: an axis of the return spring 9 and an axis of the slide hole 14 are on the same straight line; the button 8 and the slide pin 13 are articulated with each other through a pivot shaft 15; and the small spring 18 is disposed between the pivot shaft 15 and the slide hole 14. Thus, the structure is compact and the moment of force can be also produced.

An improved mode is as follows: the slider 6 is provided with a roller 16 (may also be a ball) which makes contact with the rear rod 3; and the ball track of the roller 16 runs through the slide hole 14. When the roller 16 runs through the outside of the slide hole 14 along with the slider 6, the hook block 1301 of the slide pin 13 may be pushed into the slide hole 14, so that the button 8 can bounce. In this case, the button 8 can bounce automatically and enters into the control hole 601. Thus, self-locking can be achieved and the process is more convenient.

An improved mode is as follows: the first support rod 4 and the second support rod 5 are disposed on both sides of the rear rod 3 and symmetric relative to the rear rod 3.

Thus, the folding and unfolding process is easy. In addition, the structure is simple.

An improved mode is as follows: the rear rod 3 is tubular and is provided with a solid mass 17 at a position corresponding to the button 8; the solid mass 17 is provided with a cavity; the button 8 is disposed in the cavity; the slide pin 13 is disposed in the cavity; and the size of the cavity is matched with that of the button 8. Thus, the structure is simple.

Embodiment 2: as illustrated in FIGS. 1 to 8, the present invention relates to a trolley, which comprises a left component 001 and a right component 002. The left component and the right component are respectively provided with the foregoing folded trolley structure. A front rod of the folded trolley structure in the left component and a front rod of the folded trolley structure in the right component are connected with each other to form a front frame 003. In the embodiment, the front rods are connected with each other through a cambered rod 005. The front frame is provided with front wheels. A handle stem of the folded trolley structure in the left component and a handle stem of the folded trolley structure in the right component are connected with each other to form a handle frame 004. In the embodiment, the handle stems are connected with each other through a transverse lever 006. A rear rod of the folded trolley structure in the left component and a rear rod of the folded trolley structure in the right component are respectively provided with a rear wheel. The trolley is foldable so as to reduce the space volume, is convenient to carry, can be rapidly unfolded, and is convenient to use. The front rods and the handle stems can be immediately unfolded, so that the folding and unfolding speed is rapid. In addition, the trolley has a simple structure and is easy to manufacture. The front rod and the handle stem can only be folded or unfolded by moving together, so that the structure stability is good.

The foregoing is only preferred embodiments of the present invention and not intended to limit the present invention. Any modification, equivalent replacement, improvement, etc. made within the spirit and principle of the present invention shall fall within the scope of protection of the present invention.

What is claimed is:

1. A folded trolley structure, comprising a front rod, a handle stem, a rear rod, a first support rod and a second support rod, wherein a slider capable of sliding along the rear rod is disposed on the rear rod; the front rod is articulated with an upper end of the rear rod; the handle stem is articulated with the upper end of the rear rod; an upper end of the first support rod is articulated with the front rod; a lower end of the first support rod is articulated with the slider; an upper end of the second support rod is articulated with the handle stem; a lower end of the second support rod is articulated with the slider; after sliding, the slider can drive the front end and the handle stem to be simultaneously unfolded or folded;
a fixing block fixed on the rear rod is disposed on the rear rod; the slider is provided with a control hole; the rear rod is provided with a movable button and a return spring capable of allowing the button to be extended out of the rear rod and into the control hole;
an elastically movable pull member is articulated on the fixing block; a first clamping member is disposed on the pull member; a second clamping member corresponding to the first clamping member is disposed on the slider; after the clamped connection between the first clamping member and the second clamping member, the slider and the fixing block are mutually fixed and cannot be separated; and the rear rod is provided with a slide pin capable of being driven by the button to allow the first clamping member and the second clamping member to be separated when the button is pressed.

2. The folded trolley structure according to claim 2, wherein the slide pin is disposed in the rear rod; a slide hole capable of allowing the slide pin to be extended out of the rear rod is formed at a position, corresponding to the slide pin, on the rear rod; the slider is provided with an opening at a position corresponding to the slide hole; and the position of the pull member corresponds to that of the slide hole.

3. The folded trolley structure according to claim 2, wherein the rear rod is provided with a button hole at a position corresponding to the button.

4. The folded trolley structure according to claim 3, wherein one end of the slide pin is articulated with the button and the other end is provided with a hook block; and the button is provided with a small spring capable of moving along with the button, allowing the slide pin and the button to rotate relatively, and hooking the outer edge of the slide hole after the hook block slides to the outside of the rear rod.

5. The folded trolley structure according to claim 2, wherein an axis of the return spring and an axis of the slide hole are on the same straight line; the button and the slide pin are articulated with each other through a pivot shaft; and the small spring is disposed between the pivot shaft and the slide hole.

6. The folded trolley structure according to claim 1, wherein the first clamping member is a protrusion; and the second clamping member is a bayonet clamped with the protrusion.

7. The folded trolley structure according to claim 5, wherein the slider is provided with a roller or a ball which makes contact with the rear rod; and the ball track of the roller or the ball runs through the slide hole.

8. The folded trolley structure according to claim 1, wherein the first support rod and the second support rod are disposed on both sides of the rear rod and symmetric relative to the rear rod.

9. The folded trolley structure according to claim 1, wherein the rear rod is tubular and is provided with a solid mass at a position corresponding to the button; the solid mass is provided with a cavity; the button is disposed in the cavity; the slide pin is disposed in the cavity; and the size of the cavity is matched with that of the button.

10. A trolley, comprising a left component and a right component, wherein the left component and the right component are respectively provided with the folded trolley structure according to claim 1; a front rod of the folded trolley structure in the left component and a front rod of the folded trolley structure in the right component are connected with each other to form a front frame provided with front wheels; a handle stem of the folded trolley structure in the left component and a handle stem of the folded trolley structure in the right component are connected with each other to form a handle frame; and a rear rod of the folded trolley structure in the left component and a rear rod of the folded trolley structure in the right component are respectively provided with a rear wheel.
